(19) United States
(12) Patent Application Publication
(10) Pub. No.: US 2026/0362216 A1
(43) Pub. Date: Nov. 12, 2026

(54) METHODS AND APPARATUSES FOR MULTI-RAT SPECTRUM SHARING MAC IN WIRELESS SYSTEMS

(71) Applicant: InterDigital Patent Holdings, Inc., Wilmington, DE (US)

(72) Inventors: Keiichi Kubota, Setagaya-Ku (JP); Faris Alfarhan, Montreal (CA); Martino Freda, Laval (CA); Pascal Adjakple, Great Neck, NY (US); Tuong Hoang, Montreal (CA); Dylan Watts, Montreal (CA); Brian Martin, Farnham (GB); Samuli Turtinen, Ii (FI)

(73) Assignee: InterDigital Patent Holdings, Inc., Wilmington, DE (US)

(21) Appl. No.: 19/203,941

(22) Filed: May 9, 2025

(51) Int. Cl. H04W 28/02; H04W 72/1268

(52) U.S. Cl. CPC H04W 28/0263; H04W 28/0268; H04W 28/0278; H04W 72/1268

(57) ABSTRACT

A wireless transmit/receive unit (WTRU) may receive configuration information. The configuration information may include a mapping of a first type of data flow to a RAT and/or of a second type of data flow to a second RAT. The first RAT and the second RAT may include cellular communication RATs. For example, the first RAT may include a fifth generation (5G) RAT and/or the second RAT may include a sixth generation (6G) RAT. The WTRU may determine to transmit uplink (UL) data to a network. The WTRU may receive an UL grant from the network. The WTRU may determine, based on the UL data and/or the mapping, to transmit the UL data to the network, for example via the first RAT and/or the second RAT using the UL grant. The WTRU may transmit the UL data via the determined first RAT and/or the determined second RAT.

### BACKGROUND

Dynamic spectrum sharing (DSS) may be used for a migration path from long-term evolution (LTE) to new radio (NR), for example as LTE and NR may share the same carrier. For example LTE and NR may reside in the same cell. Additionally, or alternatively, an operator may accommodate legacy users and NR users on a cell, for example where LTE and NR are deployed.

### SUMMARY

Apparatuses and methods may include medium access control (MAC) features for multiple radio access technologies (RATs). For example, there may be scheduling requests (SRs) for multi-RAT, a buffer status report (BSR) for multi-RAT, data scheduling for multi-RAT, and/or logical channel prioritization (LCP) for multi-RAT. A network (NW) may configure a wireless transmit/receive unit (WTRU) with information for mapping a (e.g., specific) logical channel, a (e.g., specific) service, and/or a (e.g., specific) quality of service (QoS) flow, with a (e.g., specific) RAT, for example new radio (NR) and/or 6G radio. The configuration information may include an indication of priority for (e.g., each) RAT.

A WTRU may have data to transmit and/or may (e.g., then) determine which RAT to use for transmission, for example based on the configuration information (e.g., priority) from the network. The WTRU may (e.g., then) send a SR, for example including an indication of prioritized RAT(s). For example, the WTRU may send an indication (e.g., by the SR) to the network that an indicated RAT(s) is prioritized for transmission of data.

The NW may send a response to the WTRU including an indication of scheduling information, for example by downlink signaling (e.g., downlink control information (DCI). The scheduling information may include an indication of which RAT(s) radio resource(s) may be used for uplink (UL) transmission and/or which RAT(s) radio resource(s) may include downlink (DL) data designated for the WTRU. For example, DCI may indicate the RAT information and/or scheduled resource blocks (RBs). The WTRU may select a RAT, for example based on the RAT mapping configuration for available user data to transmit. The WTRU may (e.g., then) generate a MAC protocol data unit (PDU) with available user data for a selected RAT, for example when UL resource(s) for the prioritized RAT is (e.g., becomes) available based on the scheduling information.

A WTRU may receive configuration information. The configuration information may include a mapping of a first type of data flow to a RAT and/or of a second type of data flow to a second RAT. The first RAT and/or the second RAT may include cellular communication, for example, third generation partnership (3GPP), RATs. For example, the first RAT may include a fifth generation (5G) RAT and/or the second RAT may include a sixth generation (6G) RAT. The WTRU may determine to transmit uplink (UL) data to a network. The WTRU may transmit, for example based on the mapping, a request to the network for a UL grant. The WTRU may receive the UL grant from the network. The WTRU may determine, based on the UL data and/or the mapping, to transmit the UL data to the network, for example via the first RAT and/or the second RAT using the UL grant. The WTRU may transmit the UL data to the network via the determined first RAT or the determined second RAT. There may be any number of determined RATs. A data flow (e.g., first type of data flow and/or second type of data flow) may be referred to as a logical channel and/or QoS flow. A data flow (e.g., first type of data flow and/or second type of data flow) may be associated with a logical channel, radio bearer, QoS flow, and/or a service.

The WTRU may determine, based on the configuration information, that the UL data comprises the second type of data flow. The WTRU may transmit the UL data to the network via the determined second RAT. The UL data may include the first type of data flow and/or the second type of data flow. The WTRU may determine, based on the mapping, to transmit UL data associated with the first type of data flow via the determined first RAT and/or to transmit UL data associated with the second type of data flow via the determined second RAT. The WTRU may transmit the first type of data flow via the determined first RAT and/or transmit the second type of data flow via the determined second RAT.

The WTRU may determine to transmit the UL data to the network via the first RAT and/or the second RAT (e.g., further) based on at least one quality of service (QoS) parameter (e.g., requirement) associated with the UL data. The WTRU may send a message to the network. The message may include an indication of an amount of the UL data. The WTRU may determine, based on the mapping, that the UL data comprises the second type of data flow. The WTRU may send, via the determined second RAT, a buffer status report (BSR) associated with the amount of the UL data. The WTRU may determine, based on the mapping, that the UL data comprises the first type of data flow and/or the second type of data flow. The WTRU may send, via the determined first RAT and/or the determined second RAT, a buffer status report (BSR) associated with the amount of the UL data.

The configuration information may include priority information. The WTRU may determine, based on the configuration information and/or the priority information, a first priority of the first UL grant and/or a second priority of the second UL grant. The second priority may be greater than the first priority. The WTRU may determine that the second type of data flow has a higher priority than the first type of data flow. The UL data may include the first type of data flow and/or the second type of data flow. The WTRU may transmit the second type of data flow using the second UL grant. The WTRU may transmit the first type of data flow using the first UL grant. The WTRU may determine, for example based on the UL data and the mapping, to transmit the UL data to the network via the second RAT using the UL grant. The WTRU may transmit a scheduling request (SR) to the network, for example based on the determination to transmit the UL data to the network via the second RAT. The SR may indicate the second RAT. The WTRU may determine an UL resource based on the second RAT. The WTRU may receive, from the network, an UL grant associated with the SR.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of multiple protocol stacks and/or logical buffers.

FIG. 3 is an example of a routing mapping rule to map data packet(s) to a user plane protocol stack for 6G and/or a user plane protocol stack for 5G.

FIG. 4 is an example of RAT separation by processing in separate protocol stacks.

### DETAILED DESCRIPTION

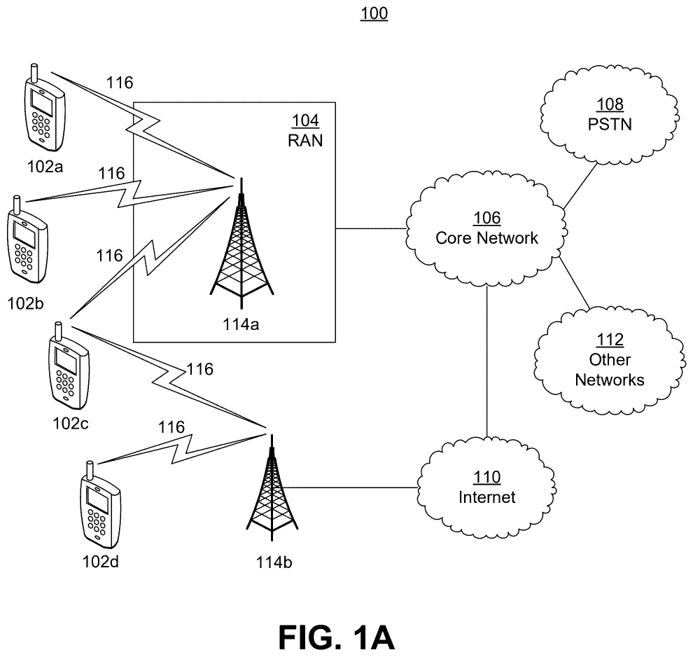

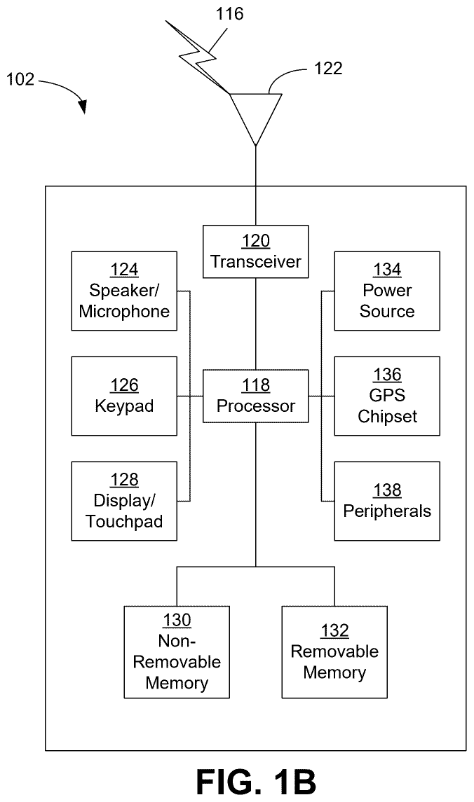

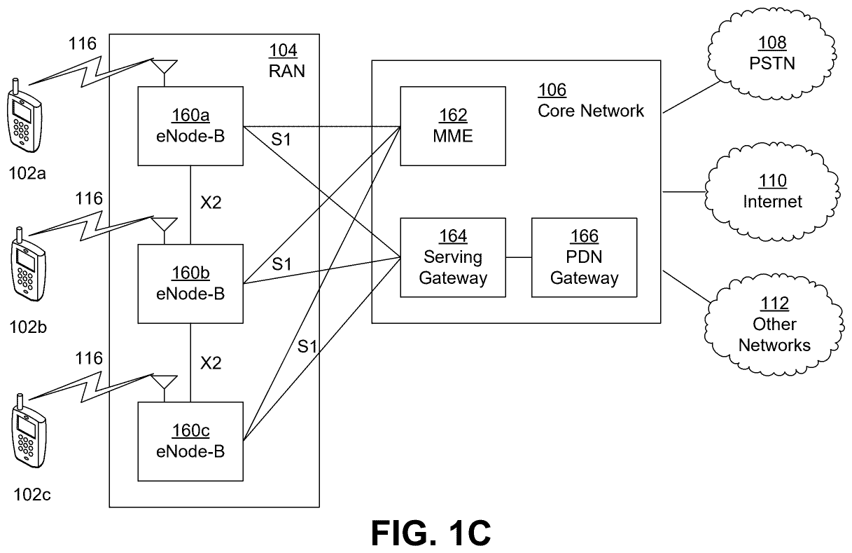

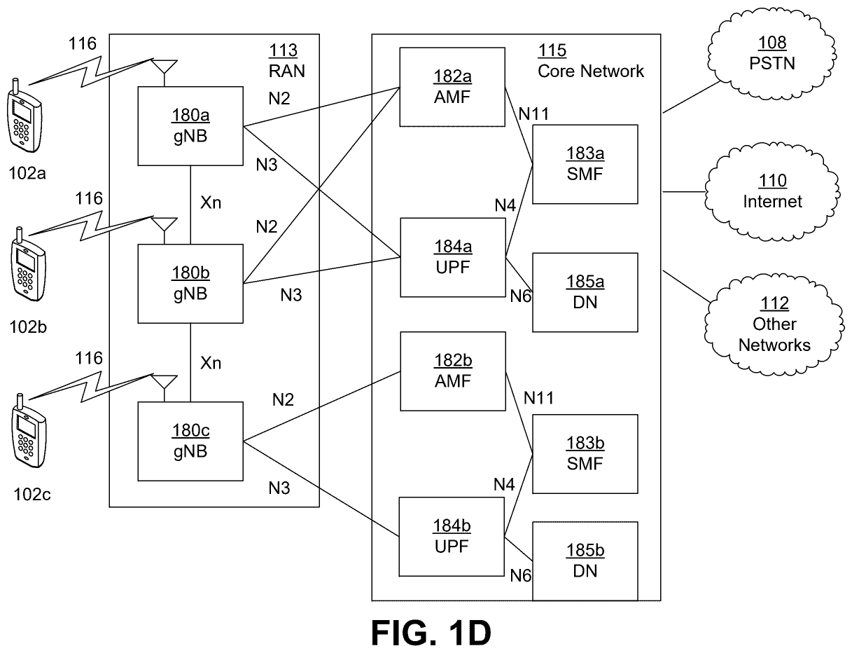

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a 6G radio base station, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, a centralized unit (CU), a distributed unit (DU), etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions. The cell may further be associated with more than one RAT. For example, the cell associated with the base station 114a may be associated with NR and 6G radio.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dynamic spectrum sharing (DSS) principles or using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, 6G radio, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For 6G a migration path from legacy radio access technology (RAT) (e.g., NR) to 6G may have DSS extended, for example for support of multiple RAT (e.g., LTE, NR, and/or 6G) spectrum sharing. Methods and apparatuses herein may provide solutions for support of user plane handling in a multi-RAT spectrum sharing environment.

Apparatuses and methods may include medium access control (MAC) features for multiple radio access technologies (RATs). For example, there may be scheduling requests (SRs) for multi-RAT, a buffer status report (BSR) for multi-RAT, data scheduling for multi-RAT, and/or logical channel prioritization (LCP) for multi-RAT. A network (NW) may configure a wireless transmit/receive unit (WTRU) with information for mapping a (e.g., specific) logical channel, a (e.g., specific) service, and/or a (e.g., specific) quality of service (QoS) flow, with a (e.g., specific) RAT, for example new radio (NR) and/or 6G radio. The configuration information may include an indication of priority for (e.g., each) RAT.

A WTRU may have data to transmit and/or may (e.g., then) determine which RAT to use for transmission, for example based on the configuration information (e.g., priority) from the network. The WTRU may (e.g., then) send a SR, for example including an indication of prioritized RAT(s). For example, the WTRU may send an indication (e.g., by the SR) to the network that an indicated RAT(s) is prioritized for transmission of data.

The NW may send a response to the WTRU including an indication of scheduling information, for example by downlink signaling (e.g., downlink control information (DCI)). The scheduling information may include an indication of which RAT(s) radio resource(s) may be used for uplink (UL) transmission and/or which RAT(s) radio resource(s) may include downlink (DL) data designated for the WTRU. For example, DCI may indicate the RAT information and/or scheduled resource blocks (RBs). The WTRU may select a RAT, for example based on the RAT mapping configuration for available user data to transmit. The WTRU may (e.g., then) generate a MAC protocol data unit (PDU) with available user data for a selected RAT, for example when UL resource(s) for the prioritized RAT is (e.g., becomes) available based on the scheduling information.

A WTRU may receive configuration information. The configuration information may include a mapping of a first type of data flow to a RAT and/or of a second type of data flow to a second RAT. The first RAT and/or the second RAT may include cellular communication, for example, third generation partnership (3GPP), RATs. For example, the first RAT may include a fifth generation (5G) RAT and/or the second RAT may include a sixth generation (6G) RAT. The WTRU may determine to transmit uplink (UL) data to a network. The WTRU may transmit, for example based on the mapping, a request to the network for a UL grant. The WTRU may receive the UL grant from the network. The WTRU may determine, based on the UL data and/or the mapping, to transmit the UL data to the network, for example via the first RAT and/or the second RAT using the UL grant. The WTRU may transmit the UL data to the network via the determined first RAT or the determined second RAT. There may be any number of determined RATs. A data flow (e.g., first type of data flow and/or second type of data flow) may be referred to as a logical channel and/or QoS flow. A data flow (e.g., first type of data flow and/or second type of data flow) may be associated with a logical channel, radio bearer, QoS flow, and/or a service.

The WTRU may determine, based on the configuration information, that the UL data comprises the second type of data flow. The WTRU may transmit the UL data to the network via the determined second RAT. The UL data may include the first type of data flow and/or the second type of data flow. The WTRU may determine, based on the mapping, to transmit UL data associated with the first type of data flow via the determined first RAT and/or to transmit UL data associated with the second type of data flow via the determined second RAT. The WTRU may transmit the first type of data flow via the determined first RAT and/or transmit the second type of data flow via the determined second RAT.

The WTRU may determine to transmit the UL data to the network via the first RAT and/or the second RAT (e.g., further) based on at least one quality of service (QoS) parameter (e.g., requirement) associated with the UL data. The WTRU may send a message to the network. The message may include an indication of an amount of the UL data. The WTRU may determine, based on the mapping, that the UL data comprises the second type of data flow. The WTRU may send, via the determined second RAT, a buffer status report (BSR) associated with the amount of the UL data. The WTRU may determine, based on the mapping, that the UL data comprises the first type of data flow and/or the second type of data flow. The WTRU may send, via the determined first RAT and/or the determined second RAT, a buffer status report (BSR) associated with the amount of the UL data.

The configuration information may include priority information. The WTRU may determine, based on the configuration information and/or the priority information, a first priority of the first UL grant and/or a second priority of the second UL grant. The second priority may be greater than the first priority. The WTRU may determine that the second type of data flow has a higher priority than the first type of data flow. The UL data may include the first type of data flow and/or the second type of data flow. The WTRU may transmit the second type of data flow using the second UL grant. The WTRU may transmit the first type of data flow using the first UL grant. The WTRU may determine, for example based on the UL data and the mapping, to transmit the UL data to the network via the second RAT using the UL grant. The WTRU may transmit a scheduling request (SR) to the network, for example based on the determination to transmit the UL data to the network via the second RAT. The SR may indicate the second RAT. The WTRU may determine an UL resource based on the second RAT. The WTRU may receive, from the network, an UL grant associated with the SR.

Methods and apparatuses herein may be discussed with respect to 5G and/or 6G, however, methods and apparatuses herein may be used for any RAT. For example, methods and apparatuses herein may be used with 3G, 4G (e.g., LTE), 5G, 6G, and/or future generation releases. References to 4G, LTE, 5G, and 6G herein are examples and may be interchangeable with any other RAT.

Methods and apparatuses may include multi-RAT spectrum sharing (MRSS) system level and/or WTRU assumptions. There may be (e.g., an assumption of) semi-static spectrum sharing. From a network perspective for example, resource(s) may be shared in a semi-static manner. For example there may be a semi-static split of resources by splitting resource blocks of orthogonal frequency division multiplex access (OFDMA), time division multiplex (TDM) (e.g. semi-static time division duplex (TDD) like split configuration), and/or frequency division multiplexing (FDM) (e.g. carrier split, bandwidth part (BWP) specific split). For example, 40% of overall OFDMA resource blocks may be assigned to one RAT (e.g. 6G radio) while the remaining 60% of resource blocks may be assigned to the other RAT (e.g. NR). A (e.g., single) cell may serve (e.g., both) 5G WTRUs and/or 6G WTRUs, for example by sharing pooled resources and/or refarming a subset of 5G spectrum and/or resources for 6G. For example 5G may look (e.g., be) backwards compatible to legacy WTRUs (e.g., with techniques added for 6G, e.g. that may affect the PHY).

From a WTRU perspective for example, a 6G WTRU may support a 5G chipset and/or a 6G chipset. For example, a 6G WTRU may support a 6G chipset only. The 6G WTRU may either operate as a 6G WTRU or a 5G WTRU and/or may not switch frequently. Mobility (e.g., L1/L2 triggering mobility (LTM), radio resource control (RRC)-based, or conditional handover (CHO)) may be used to move the WTRU from 6G to 5G and/or from 5G to 6G. The 6G WTRU may be aware of the resource split (e.g., signalled to the WTRU), or the WTRU may not be aware. The 6G WTRU may not transmit a 6G signal (e.g. with non-backwards compatible properties to the 5G design) on a configured 5G resource part for example. A (e.g., single) MAC entity may be assumed for the 6G MRSS WTRU, for example for the purpose of a serving cell that has MRSS. Additionally, or alternatively, for example if there are services that (e.g., only) a work on 5G (e.g. VoNR/voice calls), a WTRU may use a 5G MAC entity (e.g. 5G MAC protocol stack) when transmitting data on 5G resource part(s) and/or may use a separate 6G MAC entity (e.g. 6G MAC protocol stack) when transmitting on 6G resource part(s). For example, there may be differentiated MAC treatment depending on the data and/or whether service is on a 5G or 6G spectrum. A 5G WTRU may not be aware of a 6G WTRU and/or the split of resources between 6G and 5G for example.

There may be (e.g., an assumption of) dynamic spectrum sharing. From a network perspective for example, there may not be a defined split of resources between 5G and 6G. For example a split may be determined by a scheduler, for example where 5G resources may be assigned to 6G WTRUs transparently. The scheduler may use an algorithm, a resource block by resource block RAT assignment algorithm, and/or dynamic TDD, etc to handle WTRUs of different RATs. An MRSS cell may serve (e.g., both) 5G WTRUs and/or 6G WTRUs, for example by sharing pooled resources and/or refarming a subset of 5G spectrum and/or resources for 6G. Interference mitigation, for example 5G-6G tight coordination, may be desired. Mitigation may be dynamic and/or semi-static (e.g., similar to semi-static spectrum sharing). A 6G transmission adjacent to a 5G transmission may be different in terms of spectrum leakage. There may be a need for mitigation, which for example may be realized by multiplexing of independent channel conditions and/or applying other means as herein. For dedicated resources for example, the scheduler may handle resource separation and/or interference mitigation transparently to the WTRU. For common channels for example, semi-static approach/separation may be used and configured (e.g., not dependent on cell geometry).

From a WTRU perspective for example, a 6G WTRU may support a 5G chipset and a 6G chipset, or support a 6G chipset (e.g., only). A 6G WTRU transmission on a 5G resource/BWP may be controlled, for example by aligning physical (PHY) signal properties (e.g. waveform, numerology, channel coding). The WTRU may not be aware of a resource split between 5G and 6G. A 6G WTRU may have a (e.g., single) MAC entity to transmit data on an MRSS cell (e.g., regardless of used resource). In some use cases/services for example the WTRU may route the service to (e.g., only) 5G (e.g. voice over NR).

There may be (e.g., an assumption of) dual stack and/or multi-SIM/active chains operation. From a network perspective for example, the network may schedule a 6G WTRU to perform a 6G transmission/reception and/or a 5G transmission/reception on a dynamic basis within a (e.g., one) cell, for example modelled as a (e.g., one) common MAC entity or as separate MAC entities (e.g. separate protocol stacks). Dual stack and/or multi-SIM/active chains operation may include common assumptions with semi-static spectrum sharing for splitting resources. Interference management may be considered by the network, for example as in dynamic spectrum sharing.

From a WTRU perspective for example, a 6G WTRU may support a 5G chipset and a 6G chipset. A WTRU may operate both 5G and 6G RATs simultaneously (e.g. TDM, according to split structure as in semi-static spectrum sharing, r according to split ratios of OFMDA resource blocks for RAT(s), and/or one at a time. WTRU has either dual SIMs, or a single SIM/subscription with dual active chains. TDM may be used for separating UL and DL transmissions at the WTRU (e.g. 5G vs 6G). DL FDM or half duplex mode FDM may be assumed for reception of DL signals and channels (i.e. for reception of SSBs/PDCCH/PDSCH not at the same time). UL FDM or half duplex mode FDM may be assumed for transmission of UL signal and channels while receiving DL signals and channels, e.g. possibly from a different RAT. WTRU may monitor both 5G and 6G control channels. Different search spaces, control resources, or blind decoding occasions can be separate per RAT, e.g. on TDM basis. For example, the 5G WTRU may not decode 6G CCEs. The 6G WTRU may assume the structure of PDCCH to be similar to that of 5G, but may use a different assumption for decoding PDCCH. A 6G WTRU may monitor some parts of 5G PDCCH as well (e.g. first x symbols). WTRU power consumption may be scaled by multi-RAT operation, though can be optimized by aligning PDCCH monitoring occasions (e.g. by aligning DRX cycles or aligning PDCCH monitoring occasions or having them in the same over all on duration) and aligning measurement gaps and/or occasions.

There may be (e.g., an assumption of) multi-RAT carrier aggregation (CA). From a network perspective, 6G may not be deployed in an existing 5G band for example. MRSS may be from a system perspective. A cell may not mix 5G and 6G traffic in some examples.

From a WTRU perspective for example, a 6G WTRU may support a 5G chipset and a 6G chipset, or may support a 6G chipset (e.g., only). CA may be used to aggregate carriers over a 6G band and/or a 5G band, however for example this may be transparent to the WTRU. A WTRU may be modelled similar to dynamic spectrum sharing. Additionally, or alternatively, the WTRU may be aware of the RAT to carrier mapping and/or may map (e.g., transmit/receive) service specific data to the associated RAT, for example on which the service is supported/configured.

There may be WTRU modelling, for example for protocol architecture. For example for semi-static spectrum sharing and/or dynamic spectrum sharing, WTRU modelling may include a 6G WTRU operating with a (e.g., single) protocol stack, and/or resource usage of 5G vs. 6G may be abstracted in the physical layer. Additionally, or alternatively, the WTRU may have a (e.g., one) user plane (UP) stack, for example connected to two PHY entities (e.g., one for 5G and one for 6G). The 5G PHY entity may transmit and/or receive signals using a 5G transmission mode and/or a legacy 5G set of assumptions. The 6G PHY entity may transmit and/or receive signals using a 6G transmission mode and/or a new set of assumptions for 6G, for example including signal transmission properties, modulation, coding, subcarrier spacing, blind decoding, measurements, broadcast signal measurement and reception, and/or coverage enhancement, etc.

For dual stack and/or multi-SIM/active chains operation for example, the WTRU may have dual protocol stacks (e.g., one for 5G and another for 6G). Additionally, or alternatively, the WTRU may have a (e.g., single) protocol stack, that for example may be optimized to handle and/or report traffic for 5G and 6G separately.

For semi-static spectrum sharing and/or dynamic spectrum sharing for example, WTRU modelling may include a 6G WTRU operating with a (e.g., single) protocol stack, and/or resource usage of 5G vs. 6G may be abstracted in the physical layer. Additionally, or alternatively, the WTRU may have one UP stack, that for example may be connected to two PHY entities (e.g., one for 5G and one for 6G). The 5G PHY entity may transmit and/or receive signals using a 5G transmission mode and/or a legacy 5G set of assumptions. The 6G PHY entity may transmit and/or receive signals using a 6G transmission mode and/or a new set of assumptions for 6G, for example including signal transmission properties, modulation, coding, subcarrier spacing, blind decoding, measurements, broadcast signal measurement and reception, and/or coverage enhancement etc.

For dual stack and/or multi-SIM/active chain(s) operation for example, the WTRU may have dual protocol stacks (e.g., one for 5G and another for 6G). Additionally, or alternatively, the WTRU may have a (e.g., single) protocol stack, that for example may be optimized to handle and/or report traffic for 5G and 6G separately.

Example use cases may utilize L2 awareness of MRSS. For example a service may be better suited to be scheduled using 5G resources and 5G processing (e.g. voice over NR service using a semi-persistent configured grant). For voice over NR (VoNR) for example, the WTRU may be configured with a semi-static configured grant. The network may or may not share with the semi-static configured grant with other WTRUs.

A (e.g., certain) service may be served and/or processed on 6G assumptions (e.g. AI/ML, enh XR etc), which for example may have a portion of the spectrum dedicated for the service. 6G scheduling may also be enhanced, for example to support such services.

The same scheduler may be used for MRSS 6G and 5G. For example software (e.g., upgrade) may be used to enable a 5G cell to be (e.g., act as) 6G (e.g., as a use case for MRSS). Additionally, or alternatively, a different scheduler for MRSS may be used for 6G and 5G respectively, for example with scheduling coordination between the schedulers.

There may be a mapping between user data and radio access technology. For example NR and 6G radio may share the same carrier at a single cell. NR and 6G radio spectrum sharing may be useful, for example if a single WTRU supports 6G as well as NR. For example an operator may make use of the legacy feature for legacy service for the legacy WTRU and the 6G WTRU without enhancing the system of the legacy service for 6G. Additionally, or alternatively, the operator may provide a new 6G specific service over 6G radio for the 6G WTRU. Legacy service may include VoNR, multicast broadcast service (MBS), and/or etc.

A (e.g., single) cell may provide multiple RAT access services for a WTRU, which for example may be capable of the available RATs simultaneously. There may be constraints. In a legacy system for example, there may not be WTRU access to a cell via more than one RAT and/or may be no means to map between data to transmit and a (e.g., certain) RAT. For example when a WTRU attempts to transmit user data, control plane data, and/or etc. for 6G, a mapping function may be defined for uplink transmissions and/or for downlink transmissions. In legacy RAN systems, dual connectivity LTE-NR aggregation may be realized by having separate MAC instances in dual connectivity (DC), where for example each RAT may have its own MAC entity in DC. For example (e.g., therefore) a single MAC entity may not support more than one RAT per current protocol design.

3GPP may define a buffer status report (BSR), a scheduling request (SR), data scheduling and logical channel prioritisation (LCP) functionalities in legacy systems (e.g. E-UTRAN/LTE and NR), however for example all of these may assume a single MAC entity is associated with a single RAT and/or (e.g., therefore) may not handle user data with multi-RAT simultaneously. For example, BSR, SR, data scheduling and LCP in legacy systems may not work in the MRSS environment if a WTRU processes user data over multiple RAT simultaneously.

Additionally, or alternatively, 3GPP may define LCP for how uplink data may be located on an uplink MAC PDU. There may be mapping between logical channel data and specific serving cell(s), for example allowedServingCells, and/or logical channel data and specific sub-carrier spacing (SCS), which for example may be referred as BWP (e.g., allowedSCS-List). Mapping rules between specific user data and RAT may be desirable. Additionally apparatuses and methods to request uplink resources for a given RAT (e.g. for a data flow that can be served by multiple RATs) may be desirable. For example, 5G and 6G RAN components may be connected to the same core network. A data flow may (e.g., therefore) be served by either 5G or 6G RAN resources.

In 6G for example, MRSS may include a major migration path from 5G to 6G and/or a 6G WTRU may be able to access 5G and 6G RAT simultaneously. A mapping apparatus and/or method between data/service and RATs may (e.g., therefore) be desirable.

Apparatuses and methods may include RAT-aware MAC operation for MRSS, for example for mapping between data flow (e.g., logical channel, QoS flow and/or service) with one or more RAT. Data flow as herein may be used to refer to a logical channel, radio bearer, QoS flow, and/or a service/vertical.

A network may configure a WTRU with a data flow-RAT mapping configuration. The data flow-RAT mapping configuration may indicate (e.g., to the WTRU) which kind of data and/or data flow may be transmitted over a specific RAT or specific RATs. When uplink data becomes available for transmission at the WTRU for example, the WTRU may select/determine the RAT(s) for the uplink data transmission. The WTRU may select/determine the RAT(s) for the uplink data transmission based on the configuration. The WTRU may send a request to the network. The request to the network may include an indication to schedule an uplink resource/grant for the selected RAT(s), for example if an uplink resource/grant is not available for the uplink data with the selected RAT(s) at the WTRU.

If an uplink control channel is available for the selected RAT for the WTRU, the WTRU may (e.g., then) transmit a scheduling request (SR). The SR may indicate the selected RAT to request an uplink resource/grant of selected RAT(s). The WTRU may select an uplink control information (UCI) resource (e.g. PUCCH), for example associated with (e.g., configured for) the selected RAT. Additionally, or alternatively, an SR resource may be configured by the network to indicate availability of data for multiple RATs, for example due to restrictions to transmit the given data through only one RAT. The SR may include an indication of which RAT or RATs the WTRU requests for scheduling the radio resources (e.g. SR indicating 5G and 6G resources are requested to schedule). The SR may be sent over any uplink control channel available, RAT or RATs, and/or sent to a specific RAT (e.g., for the SR transmission).

If an uplink control channel is not available for the selected RAT for the WTRU for example, the WTRU may (e.g., then) perform a random-access procedure. The WTRU may perform the random-access procedure to request an uplink resource/grant for the selected RAT(s). Alternatively, or additionally, if the WTRU has SR resource available for a non-selected RAT for example, the WTRU may request UL resource(s) over the non-selected RAT and/or indicate (e.g., in the BSR and/or the SR) the availability of data over the selected RAT. The WTRU may select/determine the RAT(s) associated with the data as function of a configuration (e.g. for the data flow) and/or one or more QoS requirement(s) associated with the data (e.g. remaining time, QoS marking, core network destination, network congestion indication(s), and/or etc). Additionally, or alternatively, the data flow configuration may include the QoS requirement(s) information for the mapping.

The WTRU may report an indication of an amount of uplink data, for example available for transmission at the WTRU. For example the WTRU may send a report (e.g. BSR) including an indication of how much data to be transmitted per data flow and/or per a group of data flow(s). The WTRU may send the report, for example if an uplink resource/grant currently available is not big enough to transmit the buffered uplink data.

The WTRU may perform BSR transmission, for example to obtain an uplink resource/grant for the uplink data transmission. The WTRU may perform BSR transmission, for example per RAT BSR. For example, the BSR may include a (e.g., specific) RAT buffer status. The (e.g., specific) RAT buffer status may be sent to the (e.g., specific) RAT (e.g., only). The WTRU may perform BSR transmission, for example for all RATs. For example the BSR may include buffer status information for all RATs available on the serving cell and/or the BSR may be sent to any RAT and/or a RAT configured by network. When data of a data flow may be sent over any RAT for example, the buffer status of the data flow may be reported to (e.g., all) the RAT(s) associated with the data flow (e.g., per RAT BSR and/or a single BSR for all RATs).

The WTRU may receive an uplink resource grant. The WTRU may determine the applicable RAT for the grant. The WTRU may generate a MAC PDU for a (e.g., specific) RAT, for example by following the given uplink grant when the RAT uplink resource is (e.g., becomes) available for the WTRU. When the WTRU has uplink resource grants available for multiple RATs concurrently for example, the WTRU may determine the highest priority grant in which to transmit. The WTRU may determine the highest priority grant based on specified/configured priority rule(s) of the grants (e.g., based on RAT type, data flow priority(ies) with data available to transmit, amount of data, resource grant size, QoS parameter/requirement(s), and/or etc.). The WTRU may transmit the MAC PDU (e.g., generated MAC PDU) over the associated RAT(s).

An operator, for example having 5G and 6G spectrums, may offer a better user experience by assigning more suitable RAT's radio resources for each service (e.g. URLLC via 6G, small data transmission via 5G, etc.). Apparatuses and methods may include RAT-agnostic MAC operation for MRSS. A WTRU may be configured with one or more data flows, for example for which data from a (e.g., given) service may be serviced by a given RAT. Mapping may be agnostic to the WTRU and/or may be configured by the network. There may be a (e.g., single) protocol stack. A WTRU may process a transport block (TB) (re)-transmission using a first processing configuration associated with the data, for example if a grant is received for the first processing configuration. The WTRU may additionally, or alternatively, process a transport block (re)-transmission using second processing configuration associated with the data, for example if a grant is received for the second processing configuration.

A WTRU MAC may be configured with two PHY entities and/or TB processing configurations (e.g. one for 5G and another for 6G), an association between PHY entity/processing configuration and a group of data flows, and/or an association between one or more grant property and a PHY processing configuration to apply. The WTRU MAC may be configured with two PHY entities and/or TB processing configurations (e.g. one for 5G and another for 6G. For example, a (e.g., each) processing configuration may include assumption(s) and/or parameter(s) for processing HARQ, LCP, SR/BSR and/or TB multiplexing and/or construction. For example the WTRU may be RAT agnostic. For this RAT agnostic case for example, the WTRU may perform the layer 2 processing (e.g. SR, BSR and/or TB multiplexing) in RAT agnostic manner, and/or the network entity/entities (e.g. gNB or 6G base-station) may know the mapping between a (e.g. specific) data flow and a (e.g. specific) RAT and/or may allocate suitable RAT's radio resources (e.g. resource block(s) based on the received RAT agnostic SR and/or BSR.

The WTRU MAC may receive an uplink grant. The WTRU may determine an associated PHY processing assumption/entity. The WTRU may construct the TB, report buffered data/scheduling grant, and/or process HARQ (e.g., assume HARQ timelines, HARQ FB, and/or retransmission time and/or behaviour), for example according to the configured processing assumptions of the PHY entity and/or the associated processing configuration. The WTRU MAC may deliver the TB to the PHY entity, for example associated with the PHY processing assumption of the grant.

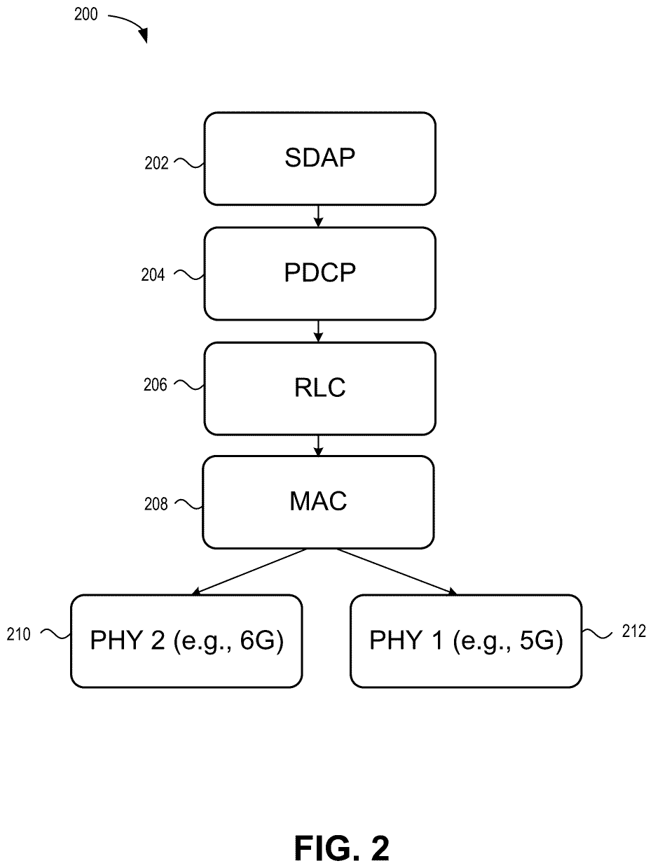

FIG. 2 is an example 200 of multiple protocol stacks and/or logical buffers. There may be multiple protocol stacks/logical buffers. A WTRU may route data to given protocol stack and/or MAC entity associated with a given RAT, for example according to a configured mapping association for a data flow, data type, and/or service. The WTRU may be configured with multiple (e.g. two) protocol stacks and/or logical buffers per flow, an SDAP 202 and/or PDCP 204 entity configured with mapping rule(s) to map data packet(s) to a user plane protocol stack, a logical buffer, and/or MAC 208 entity, and/or an association between MAC entity/logical buffer and a mapping index. The WTRU may be configured with multiple (e.g. two) protocol stacks and/or logical buffers per flow. One protocol stack may be for processing 6G data and/or another protocol stack may be for processing 5G data. For example, a protocol stack may be associated with a physical layer (e.g., PHY 2) 210 for (e.g., 6G) data and/or a protocol stack may be associated with a physical layer (e.g., PHY 1) 212 for (e.g., 5G) data. A (e.g., each) protocol stack configuration may include configurations for MAC 208, RLC 206, PDCP 204, and/or SDAP 202 parameters. The WTRU may be configured with an SDAP 202 and/or PDCP 204 entity configured with mapping rule(s) to map data packet(s) to a user plane protocol stack, a logical buffer, and/or MAC entity. A mapping may be between data type, data flow and a (e.g., given) protocol stack, and/or MAC 208 entity or mapping index.

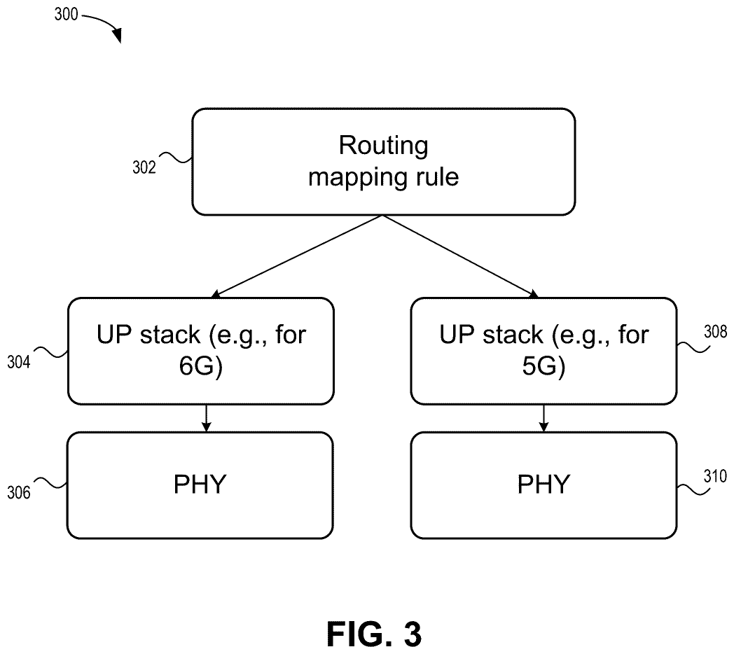

FIG. 3 is an example 300 of a routing mapping rule 302 to map data packet(s) to a user plane protocol stack (e.g., for 6G) 304 and/or a user plane protocol stack (e.g., for 5G) 308. For example, the user plane protocol stack (e.g., for 6G) 304 may be associated with a physical layer 306 (e.g., for 6G) data and/or the user plane protocol stack (e.g., for 5G) 308 may be associated with a physical layer 310 (e.g., for 5G data).

Upon arrival of an uplink packet for example, a WTRU may route the packet given protocol stack, MAC entity, and/or logical buffer associated with a mapping index, for example according to the configuration mapping association for the arrived data. The WTRU MAC may receive an uplink grant. The WTRU may report and/or transmit data at each MAC entity. Duplicate data may not be reported twice and/or may be omitted, for example once transmitted by one MAC entity.

Apparatuses and methods may enable 6G user data transfer. For example 6G user data transfer may be enabled by multi-RAT SR, multi-RAT BSR, multi-RAT data scheduling, multi-RAT LCP, and/or rule(s) for determining applicable RAT for a (e.g., given) data SDU. Table 1 shows an example configuration of data flow for MRSS MAC. The following paragraphs may be described based on the example configuration. The parameter names in the table are just examples and may be replaced with any other parameter(s).

TABLE 1

| | |
|---|---|
| DataFlowConfig ::= | SEQUENCE { |
| ul-SpecificParameters | SEQUENCE { |
| priority | INTEGER (1..16), |
| allowedRAT-List | SEQUENCE (SIZE (1..maxNrofRATs-1)) OF ratindex OPTIONAL, -- Cond |

MRSS
ratToOverride-List SEQUENCE (SIZE (1..maxNrofRATs-1)) OF RATtoOverride OPTIONAL, - Cond
MRSS-O

| | | |
|---|---|---|
| dataFlowGroup | INTEGER (0..maxDFG-ID) | OPTIONAL, -- Need R |
| schedulingRequestID | SchedulingRequestId | OPTIONAL, -- Need R |

...,

| | |
|---|---|
| } | OPTIONAL, -- Cond UL |

```
      ...
    }
DataFlowConfig field descriptions
allowedRAT-List
This restriction applies only when the UL grant is a configured grant. If present, UL MAC SDUs from this data flow
can only be mapped to the indicated configured grant configuration. If the size of the sequence is zero, then UL
MAC SDUs from this data flow cannot be mapped to any configured grant configurations. If the field is not
present, UL MAC SDUs from this data flow can be mapped to any configured grant configurations on any RAT.
Each entry indicates an index of configured RAT list
ratToOverride-List
This list provides the list of entries, which indicate which RAT's uplink scheduling can be overridden with what
RAT's uplink resources. For example, if DCI indicates NR uplink scheduling and this IE indicates that NR RAT
uplink scheduling can be overridden by 6G radio, then the 5G uplink resources can be overridden by 6G radio
uplink resources.
dataFlowGroup
ID of the data flow group, to be specified in the 6G MAC spec, which the data flow belongs to.
priority
Data flow priority, to be specified in 6G MAC spec.
schedulingRequestId
If present, it indicates the scheduling request configuration applicable for this data flow, to be specified in 6G
MAC spec. If the data flow is configured with allowedRAT-List IE, then the SR is sent over the associated RAT. If
more than one RAT is associated with the data flow, the SR is sent over the associated RAT in order of the
entries in the allowedRAT-List IE.
```

| Conditional Presence | Explanation |
|---|---|
| MRSS | The field is mandatory present if the serving cell is configured with more than one RAT |
| | (i.e. MRSS). Otherwise the field is absent, need R. |
| MRSS-O | The field is optionally present if the serving cell is configured with more than one RAT |
| | (i.e. MRSS). Otherwise the field is absent, need R. |

For support of MRSS for example, SR may be enhanced to request uplink resources for a (e.g., specific) RAT out of multiple RATs. Parameters may be configured for a SR procedure. Parameters may include sr-ProhibitTimer and/or sr-TransMax. A counter may be used, for example SR_COUNTER. Parameter(s) and/or counter may be defined per RAT (e.g., independently), for example in a 6G system. The parameter(s) and/or counter may be maintained per RAT, for example when a serving cell is configured with MRSS. When MRSS is configured for the serving cell for example, data-flow and/or RAT mapping configuration may be provided to the WTRU.

Table 1 shows an example configuration of SR for 6G data flow. For example an SR configuration may be associated with (e.g., specific) data flow(s). If the data flow(s) is configured with an allowedRAT-List IE for example, the SR (e.g., then) may be sent over the associated RAT. If more than one RAT are associated with the data flow(s) for example, the SR may be sent over the associated RAT, for example in order of the entries in the allowedRAT-List.

The WTRU may perform SR transmission in an MRSS environment, for example when MRSS is configured for the current serving cell. The WTRU may be configured. The network may provide a WTRU configuration. The configuration may include an indication of which type of data and/or which data flow(s) may be sent over on which RAT (e.g., Table 1).

There may be a (e.g., suitable) RAT determination. When uplink data becomes available at a (e.g., specific) data flow of the WTRU for example, the WTRU may identify a suitable RAT to transfer the uplink data based on the configuration. Once the suitable RAT is determined (e.g. 6G radio) and/or if uplink radio resources on the suitable RAT are not available for example, the WTRU may (e.g., then) trigger an SR procedure for the suitable RAT.

There may be initialization. If an SR is triggered and/or if there are no other SRs pending corresponding to the same SR configuration for example, the MAC entity may set the SR_COUNTER of the corresponding SR configuration to 0. When the MAC entity triggers an SR for example, the SR (e.g., counter) may be pending until cancelled.

There may be a condition check. A MAC entity may instruct the physical layer to signal the SR on one valid PUCCH resource for the SR, increment the SR_COUNTER for the RAT associated with the SR, and/or start the sr-ProhibitTimer for the RAT associated with the SR, for example if an uplink control resource (e.g. PUCCH resource) for the triggered SR is available at the RAT associated with the uplink data to be transmitted, the MAC entity has an SR transmission occasion for the PUCCH resource, a sr-ProhibitTimer for the RAT associated with the SR is not running at the SR transmission occasion, the SR transmission occasion does not overlap with any higher priority activity (e.g. measurement gap, random access, higher priority uplink PUSCH transmission, higher priority SR transmission, etc.), and/or a SR_COUNTER for the RAT associated with the SR<sr-TransMax for the RAT is associated with the SR (e.g., SR transmission).

If the PUCCH resource is not available and/or the MAC entity does not have a (e.g., any) SR transmission occasion for example, the MAC entity (e.g., then) may initiate a random access procedure. If SR_COUNTER for the RAT associated with the SR=>sr-TransMax for the RAT associated with the SR for example, the MAC entity may (e.g., then) notify RRC to release PUCCH for the RAT associated with the SR and/or release and clear any uplink resources.

There may be data transmission. The MAC entity may stop sr-ProhibitTimer, for example when the MAC entity transmits the corresponding uplink data (e.g., which triggered the SR). The MAC entity may determine that the SR is no longer pending and/or is completed. The MAC entity may cancel the SR, for example when the associated BSR is transmitted and/or multiplexed for transmission.

A priority check herein may be performed based on a configuration from the network and/or given by a MAC specification (e.g., hardcoded rule(s)). Priority may be defined, for example per RAT and/or per service.

The WTRU may be configured with an SR configuration (e.g. a set of control resources for transmitting SR, including PUCCH or PUSCH resources), for example per LCH. A (e.g., one) configuration may be used to indicate data arrival determined for a first RAT (e.g. 6G) and/or another SR configuration may be used for SR transmission to indicate data arrival determined for a second RAT (e.g. 5G). A (e.g., given) SR configuration may be used by the WTRU to indicate data arrival from a given data flow, for example that may be applicable for more than one RAT. The WTRU may maintain an SR counter, for example per selected RAT and/or per SR configuration.

For a given data flow and/or data packet arrival (e.g. that triggered BSR) for example, the WTRU may transmit a (e.g., one) SR to indicate the selected RAT. If the newly arrived data that triggered BSR is applicable for more than one RAT for example, the WTRU may signal an SR that indicates the data is applicable for more than one RAT and/or may send more than one SR (e.g. one SR for each selected RAT). The WTRU may maintain a prohibit timer per RAT and/or per SR configuration. For example for data that is determined to be applicable for more than one RAT and/or if SR is transmitted using an SR configuration for a given RAT, the prohibit timer may be started for a (e.g., all) SR configurations associated with the applicable RATs.

SR as herein may refer to an SR transmission part of uplink control information (e.g. UCI), a control element multiplexed on a data resource (e.g. a MAC CE), a PUCCH resource, and/or a random access procedure. An SR may be indicated by transmitting a BSR of a given type (e.g. a contention based BSR, a simplified BSR, or a buffer arrival status report) for example.

Apparatuses and methods may include multi-RAT BSR, for example BSR for multi-RAT spectrum sharing cell. BSR may be used to provide the network (e.g., serving base-station) with information about uplink data volume in the MAC entity. The MAC sublayer may provide data transfer services on a logical channel. In a NR system for example, up to 64 logical channels may be defined and/or logical channels grouped into several logical channel groups (LCG) (e.g., 8 LCGs). The BSR may indicate how much data is (e.g., currently) buffered for each LCG. For example, the buffer status may be reported per LCG (e.g., rather than logical channel).

There may be BSR granularity. For a 6G system for example, a (e.g., similar) grouping mechanism may be applied for BSR, for example as a 6G system may handle variety of services. For example there may be at least two options for the BSR granularity. For example buffer status may be reported per data flow (e.g., logical channel, QoS flow and/or service (e.g. eMBB and/or URLLC)). Buffer status may additionally or alternatively be reported per data group (e.g., group of logical channels, QoS flows and/or services).

Apparatuses and methods may be described with respect to buffer status reported per data flow or buffer status reported per data group, but may be applicable to the other (e.g., as well). There may be a BSR procedure, for example including BSR transmitted per RAT independently (e.g. 6G radio BSR is sent towards 6G only) and/or BSR including multi-RAT buffer status transmitted (e.g. BSR includes NR and 6G radio's buffer status by a single BSR).

There may be per RAT BSR. BSR may be sent to available RAT(s) on a cell, for example such that the network may schedule uplink data transfer via the suitable RAT for the uplink data transmissions. For example, the WTRU may report for a given data flow buffer status (e.g., data volume) for each applicable/determined RAT. For data applicable for more than one RAT for example, the WTRU may select a single RAT per data SDU and/or may report buffer status (e.g., only) for the one selected RAT. Additionally, or alternatively, data applicable for more than one RAT may be reported separately (e.g. per LCH, LCG, and/or data flow) and/or not computed as part of the data volume for the RAT-specific BSR. If data is applicable for more than one RAT for example, the WTRU may indicate buffer status for data that is (e.g., only) applicable to one RAT separately from data that is applicable more than one RAT.

The MAC entity may perform BSR. There may be a configuration, for example provided by the network (e.g., Table 1). The configuration may include an indication of which type of data and/or which data flow would belong to which data group and/or which type of data/data flow may be sent over on which RAT(s).

There may be (e.g., suitable) RAT and/or data group determination. When uplink data is (e.g., becomes) available for a specific data flow at the WTRU for example, the WTRU may identify a data group (e.g., where the data flow belongs) and/or may identify a suitable RAT for the data group based on the configuration (e.g., Table 1). The WTRU may (e.g., then) determine the data group and/or the suitable RAT to transfer the available uplink data. For example if the data flow is associated with a specific RAT, (e.g., then) the WTRU may determine (e.g., consider) the specific RAT as a suitable RAT.

There may be a BSR trigger. A BSR may be triggered, for example based on an event (e.g., an event(s) occur(s) for an activated cell group on the (e.g., suitable) RAT. The event may include UL data, for example for a data flow which belongs to a data group for the RAT becoming available to the MAC entity, the UL data belonging to a data flow with higher priority than the priority of any data flow containing available UL data which belong to any data group, and/or none of the data flows which belong to a data group contains any available UL data. The UL data may belong to a data flow with higher priority than the priority of any data flow containing available UL data which belong to any data group. For example, the priority may be determined over all the RATs and/or (e.g., only) within a single RAT. The WTRU may compare the new UL data priority to available data priorities over RATs and/or within a RAT, for example when determining whether to trigger a BSR. None of the data flows may belong to a data group contains any available UL data, which for example may be determined over all the RATs or within a RAT. A MAC subheader (e.g., by means of an LCID index) may identify the RAT applicable for a given BSR report/MAC CE.

BSR may include multi-RAT information. The BSR may include multi-RAT buffer status information, which for example may be sent to a cell such that the network may receive (e.g., all) RATs buffer status report(s) and/or schedule uplink data transfer via the suitable RAT (e.g., based on the BSR for multi-RAT).

The MAC entity may perform BSR. There may be a configuration, for example from the network (e.g., Table 1). The configuration may include an indication of which type of data may belong to which data group and/or which type of data may be sent over on which RAT. The network may explicitly configure the WTRU, for example for which RAT may be used to transmit BSR.

There may be a (e.g., suitable) RAT and/or data group determination. When uplink data is (e.g., becomes) available for a specific data flow at the WTRU for example, the WTRU may identify a data group (e.g., where the data flow belongs) and/or may identify a (e.g., suitable) RAT for the data group (e.g., based on the configuration, (e.g., Table 1)). The WTRU may (e.g., then) determine the data group and/or the suitable RAT to transfer the available uplink data, and/or may include the RAT information for a (e.g., each) entry in BSR. For example if the data flow is associated with a specific RAT, (e.g., then) the WTRU may determine (e.g., consider) the (e.g., specific) RAT as a suitable RAT.

There may be a BSR trigger. A BSR may be triggered based on an event (e.g., if any of the events occur), for example for an activated cell group on a (e.g., any) RAT and/or RAT configured for BSR. The event may include UL data, for example for a data flow which belongs to a data group, becoming available to the MAC entity, and/or the UL data belonging to a data flow with higher priority than the priority of a (e.g., any) data flow containing available UL data which belong to any data group and/or none of the data flows which belong to a data group containing any available UL data. The event may include the UL data belonging to a data flow with higher priority than the priority of a (e.g., any) data flow containing available UL data which belong to any data group. For example, the priority may be determined over all RATs or only within a single RAT. For example a WTRU may compare the new UL data priority to available data priorities over RATs and/or within a RAT when determining whether to trigger a BSR. The event may include none of the data flows which belong to a data group containing any available UL data, which for example may be determined over all the RATs or within a RAT. Additionally, or alternatively, the event may include when UL data available on a first RAT becomes greater than the UL data available on a second RAT+offset. For example the offset amount of data may be a positive, negative, or a zero value.

Data may be reported as (e.g., part of) a first group (e.g. LCG), for example if it is reported for a first RAT. Additionally, or alternatively, data may be reported as (e.g., part of) a second group (e.g., second LCG), for example if it is reported for a second RAT. Applicable groups may be configured for a given data flow per RAT. The WTRU may avoid reporting the same data twice (e.g. for more than one RAT). For example for a given data flow, the WTRU may report buffer status for RAT1, RAT2, and/or RAT1 and RAT2. In the following buffer status report for example, the WTRU may report buffer status for RAT1, RAT2, and/or RAT1 and RAT2.

| | RAT1 only | RAT2 only | RAT1 or RAT2 |
|---|---|---|---|
| LCG1 | X bits | Y bits | Z bits |

Additionally, or alternatively, a reported part of Z bits may not contain bits reported part of Y and/or X. For example the WTRU may report the number of bits that may be transmitted per RAT, for example as in the following buffer status report. X and/or Y may contain reports of the same buffered bits, for example if the data is applicable to both RATs.

| | RAT1 | RAT2 |
|---|---|---|
| LCG1 | X bits | Y bits |

Apparatuses and methods may include data scheduling for multi-RAT. For example there may be data scheduling for multi-RAT spectrum sharing cell. The network may provide uplink and/or downlink scheduling information, for example by downlink control information (DCI). The network may additionally, or alternatively, provide uplink and/or downlink scheduling information for a single RAT.

For 6G MRSS for example, cross-RAT scheduling may be defined such that the network may schedule a (e.g., single) RAT and/or other (e.g., all) available RAT(s) on the cell. The network may schedule the (e.g., single) RAT and/or other (e.g., all) available RAT(s) on the cell by a (e.g., single) downlink control signalling (e.g. downlink control information (DCI)). A 6G DCI may include RAT information and/or PUSCH and/or PDSCH scheduling information (e.g., locations of resource blocks for uplink or downlink).

DCI reception may include PDCCH carrying a (e.g., new) DCI and/or a (e.g., new) RAT PDCCH carrying a (e.g., new) DCI. PDCCH may carry a (e.g., new) DCI, which for example may indicate scheduling information for the resource(s) and/or scheduling information for the (e.g., new) RAT(s) resource(s). PDCCH may include a NR PDCCH. A (e.g., new) RAT PDCCH may carry a (e.g., new) DCI, which for example may indicate scheduling information for the new RAT(s) resource(s) and/or scheduling information for the legacy resource(s).

Additionally, or alternatively, in 6G MRSS for example, the WTRU may override the given scheduling information with different RAT resource scheduling. For example the WTRU may override the given scheduling information with different RAT resource scheduling based on the ratToOverride-List. For example (e.g., even) if 6G DCI indicates scheduling 5G resource blocks for uplink transmission, the WTRU may have more urgent user data which may utilize 6G resources. The WTRU may (e.g., therefore) transmit the 6G data with 6G techniques by using the resource blocks originally assigned to 5G data via the 6G DCI. The configuration aspects of the override are described herein.

There may be LCP for multi-RAT. There may be LCP for multi-RAT spectrum sharing cell. LCP may be within the MAC layer and/or may prioritise data transmission across different data flows/logical channels, for example when uplink resources are limited. LCP may be utilized such that higher-priority traffic may be transmitted first, for example improving resource efficiency and/or meeting QoS requirements.

For 6G MRSS deployment for example, the LCP may be enhanced such that the user data destination RAT may be controlled. Parameters may be defined, for example including allowedRAT-List, ratToOverride-List, and/or ratPriority-List. The allowedRAT-List may set the allowed RAT for transmission. The ratToOverride-List may set the allowed RAT for transmission and/or the allowed RAT that may be overridden by the other RAT given by this entry in the list. The ratPriority-List may set priorities for the allowed RATs to determine the preferred RAT, for example when granted resources exist for multiple RATs. The network may configure the allowedRAT-List for each data flow, for example such that a WTRU may know which data flow may be placed to which RAT by the configuration (e.g., Table 1).

A MAC entity may perform data flow selection, for example for uplink data transmission with multi-RAT LCP. The MAC entity may select data flows and/or data SDUs for a (e.g., each) uplink grant that satisfy a condition, for example when a new transmission is performed (e.g., when a new uplink grant becomes available at the MAC entity). The condition may include a set of allowed RAT (e.g., in allowedRAT-List) including the RAT associated with the uplink grant and/or the set of allowed RAT (e.g., in ratToOverride-List) including the RAT associated with the uplink grant. The condition may include the set of allowed RAT in allowedRAT-List, for example if configured, including the RAT associated with the uplink grant. Additionally, or alternatively, the condition may include the set of allowed RAT in ratToOverride-List, for example if configured, including the RAT associated with the uplink grant. For example if the allowed RAT is included (e.g., in the allowedRAT-List and/or the ratToOverride-List), the WTRU may override the uplink resources given by the uplink grant with the one signalled in the same entry as the uplink RAT in the list. The WTRU may allocate uplink resources chosen to the data flows selected.

The WTRU may be configured per data flow with LCP configuration parameter(s) (e.g., PBR, priority, BSD, and/or Bj) per logical buffer, for example where each logical buffer may be associated with a given RAT. For a data flow/data SDU for example, data may be buffered by a (e.g., one) logical buffer. The logical buffer may be based on the selected RAT. For example, a rule (e.g., as herein) may be used to determine (e.g., for a data SDU applicable for more than one RAT in MAC) the logical buffer (e.g. the applicable RAT/LCH) under which the WTRU buffers the data for transmission.

For a data flow or data SDU associated with more than one RAT for example, data may be buffered by more than one logical buffer. When data is allocated to a grant for example, the data may be removed from (e.g., all) applicable logical buffer(s) associated with the data SDU/data flow. The WTRU may maintain LCP parameters, for example to govern the transmission of a given data SDU per logical buffer. Bj may be reduced by the amount of data allocated in the resource allocation in LCP, for example for (e.g., all) the associated logical buffer(s) associated with the data SDU. The WTRU may maintain separate LCP parameter(s) (e.g., PRBR, priority, BSD, and/or Bj) for a (e.g., each) logical buffer, for example for uplink data. A data SDU, for example applicable for more than one RAT in MAC, may be buffered by more than one logical channel (LCH).

The WTRU may be granted uplink resources over multiple RATs concurrently. For example the granted uplink resources may overlap in a time/frequency domain. Additionally, or alternatively, the WTRU may have granted resources for multiple RATs concurrently, which for example may not overlap physically (e.g., in time/frequency domain). The WTRU may determine priority order for the grants, for example which overlap in time/frequency domain. For example the WTRU may transmit (e.g., only) over one of the grants. The priority may be based on the RAT type of the available uplink resources, data available for transmission, LCP restrictions for the data available for transmission, priority of data among priorities over multiple RATs, and/or etc. The WTRU may determine priority order for the grants to multiplex certain data and/or data flow for example. The LCP procedure may be used to determine a priority order for the data to be multiplexed for different RAT resources, which for example may be based on an explicit RAT priority list per data flow configured by the NW and/or determined by other means (e.g., remaining time of the data (before discard), uplink resource size, and/or etc.).

There may be rule(s) for determining applicable RAT for a given data SDU. RAT selection determination may be used for resource management in MRSS deployment. A WTRU may determine applicable RAT(s), for example for a certain data flow. The network may establish a data flow for a specific service. The service may be be associated with specific resources based on the service requirements and/or resource availabilities.

Data flow may be mapped with legacy RAT. For example, voice service may be associated with guaranteed bit rate (GBR) QoS and/or a service may be provided by a legacy system (e.g., only) (e.g. for the case that the new RAT is newly introduced for an operator and/or the operator has not yet implemented IMS service on the new RAT). The data flow for the voice service may be associated with the legacy system and/or the QoS enforcement may be in the legacy system. Data flow configuration may (e.g., therefore) include an indication to the WTRU to map the user data of the data flow in accordance with NR. When the user data is (e.g., becomes) available at the WTRU for example, (e.g., then) the WTRU may select NR as an applicable RAT for the data flow.

Data flow may be mapped with a new RAT. Mission critical service may be used, for example for factory automation signalling. Mission critical service may utilize ultra-reliable and/or low-latency data communication. A newer RAT may (e.g., therefore) be utilized for serving such as service, rather than a legacy RAT(s). The data flow for a URLLC service may be associated with a new RAT (e.g., 6G radio). If the user data of the data flow becomes available for example, the WTRU may select the new RAT/6G as an applicable RAT. If legacy RAT resources are available and/or 6G resources are not available for example, (e.g., then) the data flow may overwrite the available 5G resources with 6G RAT resources. The WTRU may (e.g., then) transmit the data flow data (e.g., immediately).

Data flow may be mapped with multiple RATs. A background service may be used when a large capacity communication for fast data download and/or tolerance to some amount of delay are desired, for example for a web browser and/or FTP applications. The background service may be served by a (e.g., any) available RAT(s) on the current serving cell and/or the data flow for the background service may (e.g., therefore) be associated with multiple RATs (e.g. NR and 6G radio) and/or the configuration may indicate priorities among the associated RATs. If user data of the data flow becomes available for example, the WTRU may select the associated multiple RATs (e.g., NR and 6G radio) as applicable RATs and/or may additionally or alternatively down-select (e.g., one of the) RAT(s) based on the configured priorities (e.g. select 6G radio over NR).

Table 1 shows an example data flow configuration. For example allowedRAT-List IE may include NR for a data flow of voice service resource. The WTRU may determine the applicable RAT as NR, for example when the voice data becomes available to transmit.

An allowedRAT-List IE may include 6G radio, for example for a data flow of mission critical service. Additionally, or alternatively a ratToOverride-List IE may include information indicting to the WTRU that NR resources may be overridden, for example via 6G radio resources. If user data for the data flow becomes available to transmit for example, the WTRU may (e.g., therefore) determine the applicable RAT as 6G radio. Additionally, or alternatively, if only NR uplink resources become available and/or the data flow user data needs to be sent for example, (e.g., then) the WTRU may generate the uplink data. The WTRU may send the uplink data over the 6G radio resources, which for example may override the NR uplink resources (e.g., when necessary).

An allowedRAT-List IE may include NR and 6G radio, for example with priority information for each entry. The WTRU may (e.g., then) determine the applicable RAT as one of the RATs included in the allowedRAT-List IE, for example based on the available RAT resources and/or based on the priority information for each RAT. If the 6G radio is higher priority than NR for example, (e.g., then) the WTRU may determine the applicable RAT as 6G radio (e.g., when 6G radio and NR resources are available).

The WTRU may be configured with mapping information between data flow and RAT(s). When user data becomes available for a specific data flow for example, the WTRU may determine an applicable RAT. The WTRU may determine the applicable RAT based on the mapping configuration. If only one RAT is given by the mapping configuration for the data flow for example, (e.g., then) the WTRU may select the RAT as the applicable RAT for data transmission. If more than one RAT are given by the mapping configuration for the data flow for example, (e.g., then) the WTRU may select the highest priority RAT out of the RATs given by the mapping configuration. The WTRU may select the highest priority RAT out of the RATs given by the mapping configuration based on the availability of RAT resource(s) and/or based on the priority information for a (e.g., each) RAT in the mapping configuration.

Additionally, or alternatively, if the mapping configuration provides RAT list for example, the WTRU may determine the highest priority RAT as the applicable RAT to transmit uplink data over the overridable RAT resources with the overriding RAT resources (e.g. 6G radio resources override NR resources). The RAT list may include an indication of which RAT that may be overridden by which RAT (e.g. NR resources may be overridden by 6G radio resources). If only overridable RAT resources (e.g. NR resources) are available for example, (e.g., then) the WTRU may determine the highest priority RAT as the applicable RAT to transmit uplink data over the overridable RAT resources with the overriding RAT resources (e.g. 6G radio resources override NR resources).

There may be RAT agnostic MAC operation, for example for MRSS deployment. The WTRU may be configured with one or more logical channels (e.g., data flows and/or DRBs), for example for which data from a given service for servicing by 6G and/or 5G may be routed. Mapping may be agnostic to the WTRU and/or may be configured by the network.

There may be a (e.g., single) UP stack processing data for different RAT transmission assumptions. The WTRU may be configured with a plurality (e.g. two or more) of TB processing configurations, for example for transport block processing and/or transmission. A (e.g., each) TB processing configuration may be modelled by configuration of a physical layer entity at the WTRU (e.g. a PHY entity). A (e.g., one) TB processing configuration may correspond to a physical and/or MAC layer assumption for processing the transport block, selecting one or more HARQ entity, selecting one or more HARQ entity or process, assuming a specific HARQ and/or ARQ retransmission behaviour for the TB, assuming a subset of MAC CEs or UCI that can be multiplexed on the transmission, and/or an assumption for reporting buffer status (e.g. BSR) and/or requesting a grant (e.g. SR). A (e.g., one) TB processing assumption may be associated with a behaviour for a (e.g., given) RAT (e.g. 5G or 6G) for TB processing, multiplexing, and/or reporting data arrival and/or buffered data. If the WTRU process data uses a given TB processing configuration for example, there may be an associated specified behaviour for BSR, LCP, and/or SR for the associated RAT (e.g. 5G or 6G). A TB processing configuration may be configured with a specific RAT, a RAT index, and/or a mapping index.

The WTRU may be configured with an association between a PHY entity/TB processing configuration and a group of data flows, for example such that data flows mapped to a PHY entity of a given RAT may be transmitted and/or processed (e.g. from a HARQ, LCP, BSR/SR perspective) using the configured parameters in the TB processing configuration for such PHY entity and/or the RAT assumptions specified for the RAT. If the WTRU is configured with multiple PHY entities per MAC entity (e.g. one for 5G and another for 6G) for example, the WTRU may be configured with an association between PHY entity and/or a group of data flows, for example such that data flows mapped to a PHY entity of a given RAT may be transmitted and/or processed (e.g. from a HARQ perspective) using the configured parameters for such PHY entity and/or the RAT assumptions for the transmission and HARQ.

The WTRU may be configured with one or more scheduling restrictions and/or associations (e.g. LCP restrictions), for example such that a transmission from a data flow of a given RAT may be transmitted on resources from that RAT. Restrictions may include an association between the selection of a data flow/LCH in the LCP procedure to the TB processing assumption associated with the uplink grant. For example a (e.g., each) LCH/data flow may be configured with one or more associated PHY entities and/or TB processing assumptions. When the WTRU MAC receives an uplink grant for example, the WTRU may determine an associated TB processing assumption/PHY entity. For example the WTRU may determine the associated TB processing assumption/PHY entity from the DCI indication and/or a property of the scheduling.

A property of scheduling information (e.g., an uplink grant or a downlink assignment) may include a frequency allocation, an aspect of time allocation (e.g., time instance or/and a time duration), a priority, a modulation and coding scheme, a transport block size, a number of spatial layers, a number of transport blocks to be carried, a TCI state and/or SRI, a number of repetitions, and/or whether the grant is a configured grant or a dynamic grant. An indication, for example by DCI, may include an explicit indication by a DCI field and/or by RNTI used to mask CRC of the PDCCH, an implicit indication (e.g., by a property such as DCI format), a DCI size, a CORESET and/or search space, an aggregation level, and/or an identity of a (e.g., first) control channel resource (e.g., index of first CCE) for a DCI. Mapping between the property and the value may be signalled by RRC and/or MAC.

The WTRU may construct the TB, report buffered data/scheduling grant, and/or process HARQ (e.g., assume HARQ timelines, HARQ FB, and/or retransmission time and/or behaviour), for example according to the configured underlying assumptions of the PHY entity and/or the associated TB processing configuration. When a TB is constructed for example, the WTRU MAC may deliver the TB to the PHY entity associated with the PHY processing assumption of the grant. If the WTRU is aware that data from a given data flow is transmitted and/or processed according to assumptions/configurations for a given RAT for example, the WTRU may construct the TB, report data, and/or process HARQ (e.g., assume HARQ timelines, HARQ FB, and/or retransmission time and/or behaviour). The WTRU may construct the TB, report data, and/or process HARQ according to the configured underlying assumptions of the associated RAT and/or configuration.

Data flows may be maintained agnostically to the RAT from a WTRU perspective and/or data from a given data flow may be served by an LCP restriction and/or a restriction the data flows that are applicable for a grant scheduled for a given resource (e.g. 5G vs. 6G resource/scheduling), for example when there is a (e.g., single) protocol stack.

A (e.g., one) TB processing configuration, PHY entity, and/or HARQ entity may be associated with one carrier of a given RAT (e.g. 5G) and/or a second TB processing configuration/PHY entity may be associated with one carrier of another RAT (e.g. 6G). A WTRU operating in CA may process a TB for the first TB using a first TB processing configuration for a first RAT and/or may process another TB for the second TB using the second TB processing configuration for the second RAT. The WTRU may (e.g., then) transmit the first TB and the second TB simultaneously using carrier aggregation, for example using one or two PHY entities. A (e.g., each) PHY entity and/or HARQ entity may process HARQ (e.g., HARQ timelines, HARQ feedback, HARQ processes maintenance, and/or retransmission), for example using the associated TB processing configuration and/or the defined assumptions/behaviour for the associated RAT. For a TB processed using a 5G processing configuration and/or assumption for example, the WTRU may monitor for feedback assuming the 5G control resource monitoring behaviour.

The WTRU may maintain data flows configured with TB processing assumptions associated with the target RAT in the target RAT upon handover, suspend data flows that are not applicable in the target RAT (e.g. data flows not configured with TB processing assumptions for the target RAT), and/or reroute data from the suspended data flow to the data flow of the target RAT (e.g., where an association between data flows may be configured), for example upon inter-RAT mobility (e.g., the WTRU is operating a single active protocol stack). Additionally, or alternatively, (e.g., some) data flows may be maintained for both RATs (e.g. regardless of whether the WTRU is served by a 5G cell or a 6G cell, assuming inter-RAT mobility), for example if the data flow is configured with TB processing assumptions for both RATs (e.g., source and target RATs).

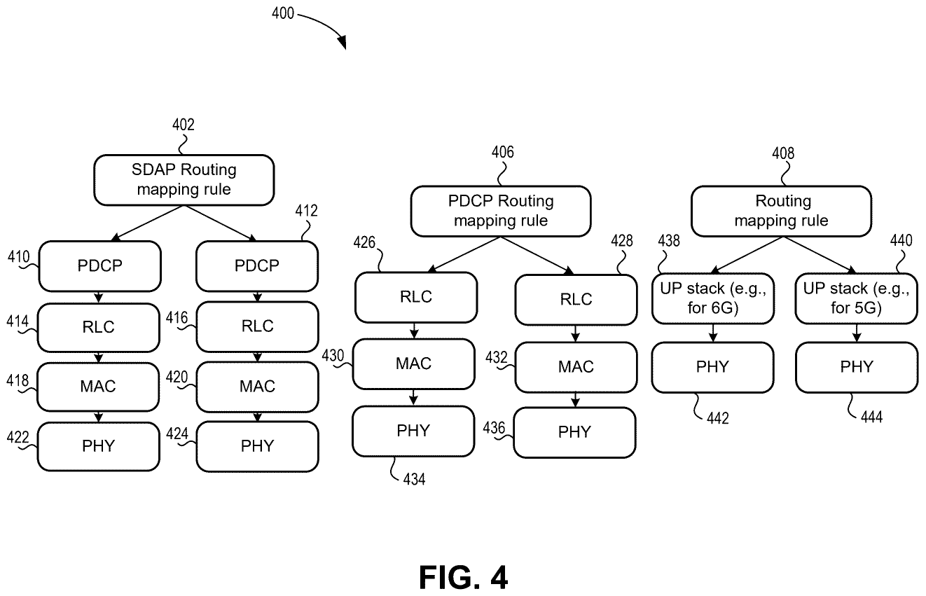

There may be RAT separation by processing in separate protocol stacks. FIG. 4 is an example 400 of RAT separation by processing in separate protocol stacks. The SDAP, PDCP layer, and/or a layer above SDAP (e.g. QoS or application interface layer) may be used to map data packets to a given data flow. One or more rules may be defined (e.g. in SDAP, a QoS layer, and/or a layer above PDCP), for example to route data to a bearer/data flow. The WTRU MAC may report BSR and/or transmits data agnostically, for example without knowing that a given service is served by resources on a given RAT.

There may be an SDAP routing mapping rule 402, a PDCP routing mapping rule 406, and/or a routing mapping rule 408. The SDAP routing mapping rule 402 may be associated with separate protocol stacks, for example with one protocol stack for 5G and one protocol stack for 6G. The protocol stack (e.g., for 5G) may include a PDCP 412, RLC 416, MAC 420, and/or PHY 424 layer. Additionally, or alternatively, the protocol stack (e.g., for 6G) may include a PDCP 410, RLC 414, MAC 418, and/or PHY 422 layer. The PDCP routing mapping rule 406 may be associated with separate protocol stacks, for example with one protocol stack for 5G and one protocol stack for 6G. The protocol stack (e.g., for 5G) may include a RLC 428, MAC 432, and/or PHY 436 layer. Additionally, or alternatively, the protocol stack (e.g., for 6G) may include a RLC 426, MAC 430, and/or PHY 434 layer. The routing mapping rule 408 (e.g., for a layer above SDAP) may include an UP stack (e.g., for 5G) 440 and/or a physical layer 444 associated with the UP stack (e.g., for 5G) 440. Additionally, or alternatively, the routing mapping rule 408 (e.g., for a layer above SDAP) may include an UP stack (e.g., for 6G) 438 and/or a physical layer 442 associated with the UP stack (e.g., for 6G) 438.

A WTRU MAC may be configured with scheduling restrictions and/or association, for example such that a transmission from a data flow of a given RAT may be transmitted on resources from that RAT and/or such that a given grant is applicable (e.g., only) to a given protocol stack. The WTRU may determine that a given grant is applicable to given protocol stack and/or a RAT index as a function of the indicated DCI, a property of the scheduling, and/or whether the grant is received from control resources from a given RAT. For example the WTRU may determine that a grant is associated with a given mapping index/TB processing configuration/RAT/RAT index if the WTRU receives the grant by scheduling from control resources of an associated RAT. For example, the WTRU may determine that a grant associated with a RAT, a protocol stack associated with a RAT, and/or a set of logical buffers associated with a RAT. The WTRU may (e.g., therefore) multiplex associated data, for example per the association configuration.

A WTRU may be configured with multiple (e.g. two) protocol stacks. One protocol stack may be for processing 6G data and/or another protocol stack may be for processing 5G data. A (e.g., each) protocol stack configuration may include configuration(s) for MAC, RLC, PDCP, and/or SDAP parameters. The WTRU may be configured with a mapping between data type, data flow and a given MAC entity or RAT index. The WTRU may be configured with an association between MAC entity and RAT.

The WTRU MAC may be configured with scheduling restrictions and/or associations, for example such that a transmission from a data flow of a given RAT may be transmitted on resources from that RAT (e.g., a grant may be specific for a given MAC entity and/or a given set of data flows associated with a RAT index). The SDAP and/or PDCP entity may be configured with mapping rule(s) to map data packets to a user plane protocol stack and/or MAC entity. Additionally, or alternatively, a mapping between data type, data flow and a given protocol stack, and/or MAC entity and/or mapping index may be configured. An association between MAC entity/logical buffer and a mapping index may be configured.

The WTRU may route/map/forward the packet to the protocol stack associated with a mapping index according to the configuration mapping association for the arrived data, for example upon arrival of an uplink packet. If the WTRU MAC receives an uplink grant for example, the WTRU may report buffer status, scheduling requests, and/or transmit data for a (e.g., each) protocol stack according to the specified data reporting and/or transmission assumptions for that RAT. The WTRU may maintain data separation by separating data flows to be mapped to the protocol stack of the associated RAT, for example when there is a dual protocol stack operation. Routing (e.g., such routing) may be performed above both stacks and/or may be coordinated between them and the WTRU buffers data separately for each protocol stack.

There may be RAT separation by processing in separate logical buffers. Logical channels/logical buffers (e.g., data with same QoS treatment) may be configured on a RAT basis, for example with the legacy LCH configuration parameters. The WTRU may route/map data SDUs to logical channels/logical buffers based on the configured mapping associations for data to an associated logical buffer, for example by indirectly selecting the RAT. The WTRU may be configured with mapping rule(s) for routing data to logical buffers. Additionally, or alternatively, the WTRU may select the RAT for a data SDU9s) based on a property of the SDU, the latency, and/or a remaining time. A rule(s) may be specified and/or predefined. The WTRU may implicitly and/or autonomously select the logical buffer to route to from a set of suitable logical channels/logical buffers. A logical channel/logical buffer may be configured for a single RAT or a plurality of RATs.

The WTRU may not be aware of an association between logical channels/logical buffers and RAT, for example until a grant is received. The WTRU may construct a TB using a given TB processing configuration and/or the associated specified protocol assumptions for the associated RAT, for example upon determining that the grant is associated with it and/or with a RAT associated with the TB processing configuration. The network may signal the TB processing assumption/configuration and/or the RAT processing assumption, for example along with an uplink grant and/or ahead of scheduling the uplink grant. The WTRU may (e.g., therefore) process the TB ahead of grant reception (e.g. based on TB pre-processing assumption, a TB processing configuration, and/or a construction with RAT hypothesis/specification).

The WTRU may be configured with a plurality of (e.g. two) logical buffers per flow, for example where each logical buffer may be configured with an associated mapping index and/or an associated RAT and/or RAT index. The SDAP and/or PDCP entity may be configured with one or more mapping rules, for example to map data packets to a logical buffer.

The WTRU may be configured with a mapping between data type, for example such that a higher layer packet marking and a given mapping index may be configured. The data type may include a condition that may be met as a function of inclusion of data from a given type (e.g. AI/ML, XR, sensing, volumetric video, operational data, model transfer data, and/or inference data). For a data unit containing AL/ML data or sensing data for example, the WTRU may associate a data unit with a given logical buffer and/or RAT index.

The WTRU may route/map/forward the packet to the logical buffer associated with a mapping index according to the configuration mapping association for the arrived data, for example upon arrival of an uplink packet. If the WTRU MAC receives an uplink grant for example, the WTRU may report buffer status, schedule request(s), and/or transmit data for a (e.g., each) logical buffer according to legacy data reporting and/or transmission assumptions.

Data flows may be maintained agnostically to the RAT from a WTRU perspective and/or data from a given data flow may be served by an LCP restriction and/or a restriction the data flows that are applicable for a grant scheduled for a given resource (e.g. 5G vs. 6G resource/scheduling), for example assuming a single protocol stack. A grant may be tagged with a mapping index and/or a RAT index, which for example may be conveyed via a DCI indication and/or a property of the scheduling.

Duplicate data may not be reported twice and/or may be omitted, for example once transmitted by one logical buffer. For example if an associated logical buffer has transmitted that data and/or if the same data is routed to both logical buffers, duplicate data may not be reported twice.

There may be 6G MAC for MRSS deployment. A network may configure a WTRU with a data flow-RAT mapping configuration. The data flow-RAT mapping configuration may indicate (e.g., to the WTRU) which kind of data and/or data flow may be transmitted over a specific RAT or specific RATs. When uplink data becomes available for transmission at the WTRU for example, the WTRU may select/determine the RAT(s) for the uplink data transmission. The WTRU may select/determine the RAT(s) for the uplink data transmission based on the configuration. The WTRU may send a request to the network. The request to the network may include an indication to schedule an uplink resource/grant for the selected RAT(s), for example if an uplink resource/grant is not available for the uplink data with the selected RAT(s) at the WTRU.

If an uplink control channel is available for the selected RAT for the WTRU, the WTRU may (e.g., then) transmit a SR. The SR may indicate the selected RAT to request an uplink resource/grant of selected RAT(s). The WTRU may select an uplink control information (UCI) resource (e.g. PUCCH), for example associated with (e.g., configured for) a selected RAT. Additionally, or alternatively, an SR resource may be configured by the network to indicate availability of data for multiple RATs, for example due to restrictions to transmit the given data through only one RAT.

If an uplink control channel is not available for the selected RAT for the WTRU for example, the WTRU may (e.g., then) perform a random-access procedure. The WTRU may perform the random-access procedure to request an uplink resource/grant for the selected RAT(s). Alternatively, or additionally, if the WTRU has SR resource available for a non-selected RAT for example, the WTRU may request UL resource(s) over the non-selected RAT and/or indicate (e.g., in the BSR) the availability of data over the selected RAT. The WTRU may select/determine the RAT(s) associated with the data as function of a configuration (e.g. for the data flow) and/or one or more QoS requirement(s) associated with the data (e.g. remaining time, QoS marking, core network destination, network congestion indication(s), and/or etc).

The WTRU may report an indication of an amount of uplink data, for example available for transmission at the WTRU. For example the WTRU may send a report including an indication of how much data to be transmitted per data flow and/or per a group of data flow(s). The WTRU may send the report, for example if an uplink resource/grant currently available is not big enough to transmit the buffered uplink data.

The WTRU may perform BSR transmission, for example to obtain an uplink resource/grant for the uplink data transmission. The WTRU may perform BSR transmission, for example per RAT BSR. For example, the BSR may include a (e.g., specific) RAT buffer status. The (e.g., specific) RAT buffer status may be sent to the (e.g., specific) RAT (e.g., only). The WTRU may perform BSR transmission, for example for all RATs. For example the BSR may include buffer status information for all RATs available on the serving cell and/or the BSR may be sent to any RAT and/or a RAT configured by network. When data of a data flow may be sent over any RAT for example, the buffer status of the data flow may be reported to (e.g., all) the RATs associated with the data flow (e.g., per RAT BSR and/or for all RATs).

The WTRU may receive an uplink resource grant. The WTRU may determine the applicable RAT for the grant. The WTRU may generate a MAC PDU for a (e.g., specific) RAT, for example by following the given uplink grant when the RAT uplink resource is (e.g., becomes) available for the WTRU. When the WTRU has uplink resource grants available for multiple RATs concurrently for example, the WTRU may determine the highest priority grant in which to transmit. The WTRU may determine the highest priority grant based on specified/configured priority rule(s) of the grants (e.g., based on RAT type, data flow priority (ies) with data available to transmit, amount of data, resource grant size, and/or etc.). The WTRU may transmit the MAC PDU (e.g., generated MAC PDU) over the associated RAT(s).

1. A wireless transmit/receive unit (WTRU) comprising:
a processor configured to:
receive configuration information, the configuration information comprising a mapping of a first type of data flow to a first radio access technology (RAT) and of a second type of data flow to a second RAT, wherein the first RAT and the second RAT comprise cellular communication RATs;
determine to transmit uplink (UL) data to a network;
transmit, based on the mapping, a request to the network for a UL grant;
receive the UL grant from the network;
determine, based on the UL data and the mapping, to transmit the UL data to the network via the first RAT or the second RAT using the UL grant; and
transmit the UL data to the network via the determined first RAT or the determined second RAT.

2. The WTRU of claim 1, wherein the processor is configured to:
determine, based on the configuration information, that the UL data comprises the second type of data flow; and
transmit the UL data to the network via the determined second RAT.

3. The WTRU of claim 1, wherein the UL data comprises the first type of data flow and the second type of data flow, and wherein the processor is configured to:
determine, based on the mapping, to transmit the first type of data flow via the determined first RAT and to transmit the second type of data flow via the determined second RAT; and
transmit UL data associated with the first type of data flow via the determined first RAT and transmit UL data associated with the second type of data flow via the determined second RAT.

4. The WTRU of claim 1, wherein the processor is configured to determine to transmit the UL data to the network via the first RAT or the second RAT further based on at least one quality of service (QOS) parameter associated with the UL data, and wherein the first type of data flow and the second type of data flow are associated with at least one of a logical channel, a radio bearer, a QoS flow, or a service.

5. The WTRU of claim 1, wherein the processor is configured to send a message to the network, the message comprising an indication of an amount of the UL data.

6. The WTRU of claim 5, wherein the processor is configured to:
determine, based on the mapping, that the UL data comprises the second type of data flow; and
send, via the determined second RAT, a buffer status report (BSR) associated with the amount of the UL data.

7. The WTRU of claim 5, wherein the processor is configured to:
determine, based on the mapping, that the UL data comprises the first type of data flow and the second type of data flow; and
send, via one or more of the determined first RAT or the determined second RAT, a buffer status report (BSR) associated with the amount of the UL data.

8. The WTRU of claim 1, wherein the UL grant comprises a first UL grant and a second UL grant, wherein the configuration information comprises priority information, and wherein the processor is configured to:
determine, based on the priority information, a first priority of the first UL grant and a second priority of the second UL grant, wherein the second priority is greater than the first priority, and wherein the UL data comprises the first type of data flow and the second type of data flow;
determine that the second type of data flow has a higher priority than the first type of data flow;
transmit the second type of data flow using the second UL grant; and
transmit the first type of data flow using the first UL grant.

9. The WTRU of claim 1, wherein the processor is configured to:
determine, based on the UL data and the mapping, to transmit the UL data to the network via the second RAT using the UL grant;
transmit, based on the determination to transmit the UL data to the network via the second RAT, a scheduling request (SR) to the network, the SR indicating the second RAT;
determine a UL resource based on the second RAT; and
receive, from the network, the UL grant, the UL grant associated with the SR.

10. The WTRU of claim 1, wherein the first RAT comprises a fifth generation (5G) RAT and the second RAT comprises a sixth generation (6G) RAT.

11. A method performed by a wireless transmit/receive unit (WTRU), the method comprising:
receiving configuration information, the configuration information comprising a mapping of a first type of data flow to a first radio access technology (RAT) and of a second type of data flow to a second RAT, wherein the first RAT and the second RAT comprise cellular communication RATs;
determining to transmit uplink (UL) data to a network;
transmitting, based on the mapping, a request to the network for a UL grant;
receiving an UL grant from the network;
determining, based on the UL data and the mapping, to transmit the UL data to the network via the first RAT or the second RAT using the UL grant; and
transmitting the UL data to the network via the determined first RAT or the determined second RAT.

12. The method of claim 11, comprising:
determining, based on the configuration information, that the UL data comprises the second type of data flow; and
transmitting the UL data to the network via the determined second RAT.

13. The method of claim 11, wherein the UL data comprises the first type of data flow and the second type of data flow, and wherein the method comprises:
determining, based on the mapping, to transmit the first type of data flow via the determined first RAT and to transmit the second type of data flow via the determined second RAT; and
transmitting UL data associated with the first type of data flow via the determined first RAT and transmitting UL data associated with the second type of data flow via the determined second RAT.

14. The method of claim 11, comprising determining to transmit the UL data to the network via the first RAT or the second RAT further based on at least one quality of service (QoS) parameter associated with the UL data, and wherein the first type of data flow and the second type of data flow are associated with at least one of a logical channel, a radio bearer, a QoS flow, or a service.

15. The method of claim 11, comprising sending a message to the network, the message comprising an indication of an amount of the UL data.

16. The method of claim 15, comprising:
determining, based on the mapping, that the UL data comprises the second type of data flow; and
sending, via the determined second RAT, a buffer status report (BSR) associated with the amount of the UL data.

17. The method of claim 15, comprising:
determining, based on the mapping, that the UL data comprises the first type of data flow and the second type of data flow; and
sending, via one or more of the determined first RAT or the determined second RAT, a buffer status report (BSR) associated with the amount of the UL data.

18. The method of claim 11, wherein the UL grant comprises a first UL grant and a second UL grant, wherein the configuration information comprises priority information, and wherein the method comprises:
determining, based on the priority information, a first priority of the first UL grant and a second priority of the second UL grant, wherein the second priority is greater than the first priority, and wherein the UL data comprises the first type of data flow and the second type of data flow;
determining that the second type of data flow has a higher priority than the first type of data flow;
transmitting the second type of data flow using the second UL grant; and
transmitting the first type of data flow using the first UL grant.

19. The method of claim 11, comprising:
determining, based on the UL data and the mapping, to transmit the UL data to the network via the second RAT using the UL grant;
transmitting, based on the determination to transmit the UL data to the network via the second RAT, a scheduling request (SR) to the network, the SR indicating the second RAT;
determining an UL resource based on the second RAT; and
receiving, from the network, the UL grant, the UL grant associated with the SR.

20. The method of claim 11, wherein the first RAT comprises a fifth generation (5G) RAT and the second RAT comprises a sixth generation (6G) RAT.
